(19) United States
(12) Patent Application Publication
(10) Pub. No.: US 2016/0223333 A1
(43) Pub. Date: Aug. 4, 2016

(54) ROUTE DETERMINATION USING NEIGHBOR AWARENESS NETWORK DEVICES

(71) Applicant: QUALCOMM Incorporated, San Diego, CA (US)

(72) Inventors: Sidharth Ram Thakur, San Jose, CA (US); Alireza Raissinia, Monte Sereno, CA (US)

(21) Appl. No.: 14/609,912

(22) Filed: Jan. 30, 2015

(51) Int. Cl. G01C 21/00; H04W 8/00

(52) U.S. Cl. CPC G01C 21/00; H04W 8/005; H04W 84/10

(57) ABSTRACT

Methods, systems, and devices are described for determination of a route through a geographic area using neighbor awareness network (NAN) devices. A plurality of NAN devices may be distributed throughout a geographic area and may monitor the environmental conditions of their respective locations. The NAN devices may relay the environmental condition information to a route determining device, which may determine a route through the geographic area. The determined route may be based at least in part on the environmental condition information received from the NAN devices. The route determined route may be communicated to a mobile target associated with the geographic area.

### BACKGROUND

1. Field of Disclosure

The following relates generally to wireless communication, and more specifically to the determination of routes using neighbor awareness network (NAN) devices.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

Neighbor Awareness Networking (NAN) refers to a self-configuring peer-to-peer organization of wireless devices that enables the wireless devices to synchronize with each other and discover each other's services. The NAN cluster may be organized when a number of NAN-capable wireless devices converge in an area and discover each other. Once the wireless devices have synchronized their timings, the wireless devices may advertise their respective services to each other during an agreed upon discovery window, which increases the probability of mutual service discovery among the wireless devices in the cluster.

### SUMMARY

The present disclosure relates generally to wireless communications systems, and more particularly to improved systems, methods, or apparatuses for route determination using neighbor awareness network (NAN) devices. A cluster of NAN devices may monitor the environmental conditions of their respective locations within a geographic area and relay the environmental conditions to a route determining device. The route determining device may analyze the environmental condition information reported by the NAN devices and determine a route through the geographic area. The route determining device may detect an anomaly or a hazardous condition in a certain location or portion of the geographic area based on the information provided by the NAN devices, then determine a route through the geographic area that avoids the anomaly or hazardous condition. The route determining device may communicate the selected route to a mobile target (e.g., a person or a device in or near the geographic area), thereby enabling the mobile target to traverse the geographic area according to the selected route.

The route determining device may receive the environmental condition information from the NAN devices using service discovery frames. Each NAN device may transmit a service discovery frame downstream (i.e., towards the route determining device) through the NAN cluster, the service discovery frame including environmental condition information observed at the location of that NAN device. Thus, downstream NAN devices may, in addition to transmitting their own environment conditional information, relay service discovery frames from upstream NAN devices carrying environmental condition information observed by the upstream NAN devices.

A method of wireless communication at a route determining device is described. The method may include receiving environmental condition information from a plurality of NAN devices distributed throughout a geographic area and determining a route through a geographic area. The route may be based at least in part on the environmental condition information. The method may further include communicating the route to a mobile target associated with the geographic area.

An apparatus for wireless communication at a route determining device is described. The apparatus may include means for receiving environmental condition information from a plurality of NAN devices distributed throughout a geographic area and means for determining a route through a geographic area. The route may be based at least in part on the environmental condition information. The apparatus may further include means for communicating the route to a mobile target associated with the geographic area.

A further apparatus for wireless communication at a route determining device is described. The apparatus may include a processor, memory in electronic communication with the processor, and instructions stored in the memory. The instructions may be executable by the processor to receive environmental condition information from a plurality of NAN devices distributed throughout a geographic area and determine a route through a geographic area. The route may be based at least in part on the environmental condition information. The instructions may be further executable by the processor to communicate the route to a mobile target associated with the geographic area.

A non-transitory computer-readable medium storing code for wireless communication at a route determining device is described. The code may include instructions executable to receive environmental condition information from a plurality of NAN devices distributed throughout a geographic area and determine a route through the geographic area. The route may be based at least in part on the environmental condition information. The code may include instructions executable to communicate the route to a mobile target associated with the geographic area.

Receiving the environmental condition information may include receiving a first service discovery frame from a first NAN device of the plurality of NAN devices. The first service discovery frame may include the environmental condition information. Receiving the environmental condition information may include receiving a second service discovery frame from the first NAN device. The second service discovery frame may include additional environmental condition information related to a second NAN device of the plurality of NAN devices.

The service discovery frame may include a service information field conveying the environmental condition information. Additionally or alternatively, the service discovery frame may include a service identification field conveying the environmental condition information.

An anomaly may be detected within the physical area based on the environmental condition information, and the determined route may indicate a path for the mobile target to traverse the geographic area. The route may indicate physical areas to avoid within the geographic area. A location associated with a NAN device of the plurality of the NAN devices may be identified, and the route may be further based on the location of the NAN device.

The environmental condition information may be received periodically. The environmental condition information may additionally or alternatively be received based at least in part on a change in the environmental condition information. The environmental condition information may be received if the change in the environmental information satisfies a threshold. Additionally or alternatively, the environmental condition information may include a parameter selected from the group consisting of air quality information, temperature information, visibility information, imagery, audio, and video.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system configured in accordance with various aspects of the present disclosure;

FIG. 2 illustrates an example of a NAN cluster in accordance with various aspects of the present disclosure;

FIG. 3 illustrates an example of a NAN cluster relay for determining a route through a geographic area in accordance with various aspects of the present disclosure;

FIG. 4 illustrates an example of a process flow for determining a route through a geographic area in accordance with various aspects of the present disclosure;

FIG. 5 illustrates an example of a flowchart for determining a route through a geographic area in accordance with various aspects of the present disclosure;

FIG. 6 shows a block diagram of a route determining device in accordance with various aspects of the present disclosure;

FIG. 7 shows a block diagram of a route determining device in accordance with various aspects of the present disclosure;

FIG. 8 shows a block diagram of a route manager in accordance with various aspects of the present disclosure;

FIG. 9 illustrates a block diagram of a system including a route determining device in accordance with various aspects of the present disclosure;

FIG. 10 shows a flowchart illustrating a method for determining a route through a geographic area in accordance with various aspects of the present disclosure;

FIG. 11 shows a flowchart illustrating a method for determining a route through a geographic area in accordance with various aspects of the present disclosure;

FIG. 12 shows a flowchart illustrating a method for determining a route through a geographic area in accordance with various aspects of the present disclosure;

FIG. 13 shows a flowchart illustrating a method for determining a route through a geographic area in accordance with various aspects of the present disclosure; and

### DETAILED DESCRIPTION

The described features generally relate to improved systems, methods, or apparatuses for determination of a route through a geographic area using neighbor awareness network (NAN) devices. In some situations, a person may enter an environment with dynamic environmental conditions. When visibility is poor or the environment experiences fast, unanticipated changes, the person may not have information regarding the status of the route they used to get to their present location. In some cases, the changes may be such that the route is rendered impassable. However, the person may not realize the status of the route until the route is physically encountered (e.g., the person may attempt to exit the area via the same route by which they entered, only to discover the route is unnavigable). Thus, a communication system may be used to relay information (e.g., the status of a route) to a base station or the person, which may reduce the time a person spends searching for a passable route.

For example, a neighbor awareness network (NAN) may be used to create a virtual trail of bread crumbs to a person. The person may traverse an area and distribute NAN-capable devices. The NAN-capable devices may advertise periodic updates of the environment at their respective location such as temperature, visibility, air quality, etc. The environmental information may be relayed by the NAN-capable devices to a route determining device, which may use the information to determine a route for the person. Once the route has been determined, the route determining device may communicate the route information to the person.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

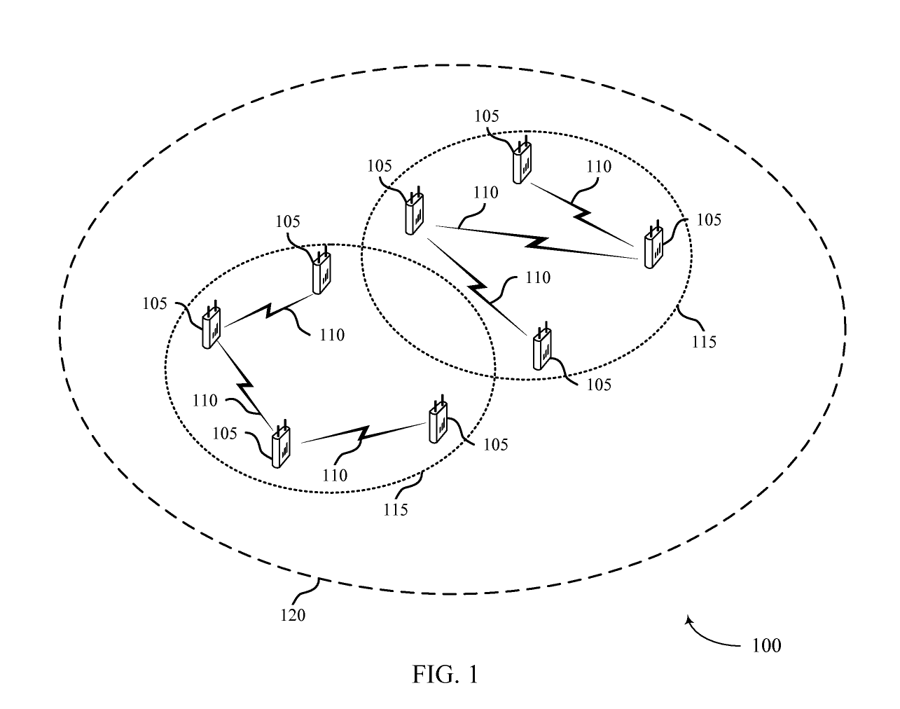

FIG. 1 illustrates an example of a wireless communications system 100 for determining a route through a geographic area in accordance with various aspects of the present disclosure. The wireless communications system 100 includes a number of NAN devices 105 in communication with each other via wireless communication links 110. A NAN device 105 may be any device capable of communicating according to NAN protocols and may include sensors, personal digital assistants (PDAs), mobile communication devices (e.g., phones, tablets, and laptops), and the like. In some cases, a NAN device 105 may be a wireless station (STA) capable of accessing wireless local area networks (WLANs) such as Wi-Fi basic service sets (BSSs), independent basic service sets (IBSSs), and Wi-Fi Direct connections. In some examples, a NAN device 105 may be referred to as a NAN-capable device, NAN sensor, NAN unit, or other terminology.

A group of NAN devices 105 which are synchronized to a common timing scheme and which collectively operate according to a common set of NAN parameters may make up a NAN cluster 115. A group of NAN devices 105 which are not necessarily synchronized but which share common NAN parameters (e.g., beacon interval and NAN channels) may form a NAN network 120. Thus, a NAN network 120 may include one or more NAN clusters 115. In order to join a NAN cluster 115, a NAN device 105 may synchronize its clock to the timing scheme of the NAN cluster 115 using a synchronization beacon broadcast by one or more NAN devices 105 already within the NAN cluster 115. Once synchronized to the NAN cluster 115, a NAN device 105 may communicate with other NAN devices 105 in the NAN cluster 115 by transmitting and receiving signals during a discovery window (i.e., a time period and channel on which all NAN devices 105 within NAN cluster 115 converge to exchange synchronization and service information). A NAN device 105 may discover the presence of a nearby NAN cluster 115 based on a discovery beacon broadcast which may be broadcast in between synchronization beacons and outside of discovery windows.

Different NAN devices 105 may assume or be assigned different roles within a NAN cluster 115. A NAN device 105 may serve as either a master NAN device 105 or a non-master NAN device 105 (i.e., a NAN device 105 may be in a master mode or a non-master mode). A NAN device 105 may identify its role within the NAN cluster 115 based at least in part on the received signal strength indicator (RSSI) of a signal received from the nearest master NAN device 105 (e.g., if the RSSI of the nearest master NAN device 105 is below a threshold, the NAN device 105 may assume the role of a master NAN device 105). A non-master NAN device 105 may be in one of two states: a sync state or a non-sync state. While in a sync state, a non-master NAN device 105 may transmit synchronization beacons, but not discovery beacons. While in a non-sync state, a non-master NAN device 105 may not transmit synchronization beacons or discovery beacons. However, a master NAN device 105 may transmit both synchronization beacons and discovery beacons. A master NAN device 105 which is responsible for supplying the system timing for a NAN cluster 115 may be known as an anchor master. For example, an anchor master NAN device 105 may broadcast a timing synchronization function (TSF) to other NAN devices 105 in the NAN cluster 115 via synchronization beacons. Thus, the timing of all NAN devices 105 within the NAN cluster 115 may be synchronized according to the TSF.

A NAN device 105 may identify services offered by other NAN devices 105 via service discovery frames, which may be transmitted by master NAN devices 105 or non-master NAN devices 105. A service discovery frame may be a Vendor Specific Public Action Frame, as defined in IEEE Std. 802.11-2012. Within a NAN cluster 115, service discovery frames may be multicast (i.e., sent from one NAN device 105 to multiple NAN devices 105) or unicast (i.e., sent from one NAN device 105 to another NAN device 105). The service discovery frames may include fields for the transmission of data from one NAN device 105 to another. For example, a NAN device 105 may transmit information to a different NAN device 105 via a service descriptor attribute, which may be one of the NAN attributes included in a service discovery frame. Thus, a NAN device 105 may use a service discovery frame to transmit information corresponding to itself, or relay information received from another NAN device 105.

A NAN device 105 may be equipped to monitor various aspects of its surroundings. For example, a NAN device 105 may be configured to sense or monitor environmental conditions such as air quality, visibility, temperature, humidity, visual appearance, noise or audio conditions, seismic conditions, etc. A NAN device 105 may communicate with an intelligent device capable of receiving information and make decisions based on said information. For instance, a route determining device may receive environmental condition information for different locations within a geographic area, as monitored and reported by NAN devices 105 through a NAN cluster 115, and determine a physical route through the geographic area based on the environmental information reported by the NAN devices 105.

In other words, a NAN cluster 115 of NAN devices 105 may monitor the environmental conditions of their respective locations within a geographic area and relay the environmental conditions to a route determining device. The route determining device (e.g., a NAN anchor master or other device) may analyze the environmental condition information and determine a route through the geographic area. The route determining device may detect an anomaly or a hazardous condition in a certain location or portion of the geographic area based on the information provided by the NAN devices 105 and determine a route through the geographic area that avoids the anomaly or hazardous condition. The route determining device may communicate the selected route to a mobile target (e.g., a person or a device in or near the geographic area), thereby enabling the mobile target to traverse the geographic area according to the selected route.

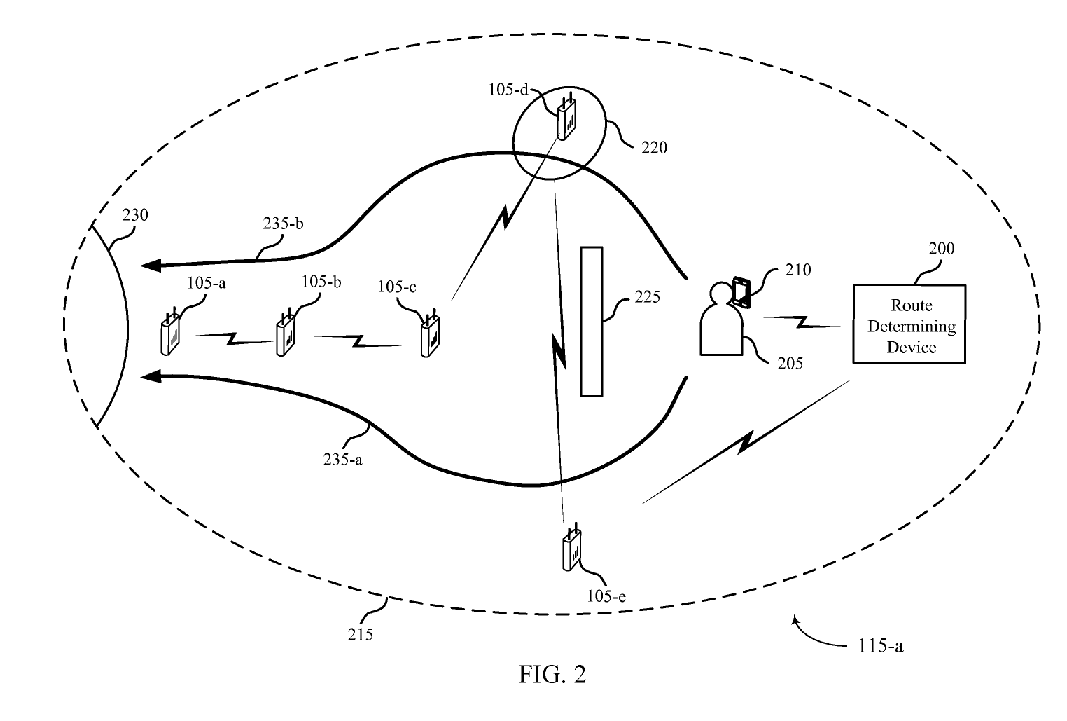

FIG. 2 illustrates an example of a NAN cluster 115-a in accordance with various aspects of the present disclosure. The NAN cluster 115-a may include various NAN devices 105, which may be examples of one or more of the NAN devices 105 described above with reference to FIG. 1. The NAN devices 105 shown in FIG. 2 may all be master NAN devices 105. Alternatively, a subset of the NAN devices 105 in the NAN cluster 115-a may be master NAN devices 105. NAN cluster 115-a may include a route determining device 200 and a mobile target, which may be a person 205 or a device 210 associated with the person 205. Each NAN device 105 may communicate with a neighboring NAN device 105 according to the NAN communication scheme generally described above with reference to FIG. 1. The NAN devices 105 of the NAN cluster 115-a may be distributed throughout a geographic area 215, which may include an enclosed area (e.g., a building), an open space (e.g., a forest), or a combination of the two.

The NAN devices 105 may be distributed manually throughout the geographic area 215 (e.g. the NAN devices 105 may be dropped by a person 205), or automatically, via an automated mechanism (e.g., one carried by a person 205). The NAN devices 105 may be distributed at regular intervals (e.g., according to a timer or pedometer) or at irregular intervals (e.g., according to the RSSI of the last beacon). More than one NAN device 105 may be dropped at a time, which may increase the robustness of the NAN cluster 115-a through redundancy. The NAN devices 105 may monitor the environmental conditions of their respective locations and communicate the information via service discovery frames (e.g., via service information fields or service identification fields). For instance, a NAN device 105 may communicate via service discovery frames with two other NAN devices 105 (e.g., an upstream NAN device 105 and a downstream NAN device 105), the selection of which may be based on distance, RSSI, hop count (i.e., the order in which the NAN devices 105 are dropped), or other criteria. The NAN devices 105 may convey information corresponding to their locations using the service discovery frames or other types of messages.

A NAN device 105 may communicate environmental condition information that corresponds to a different NAN device 105 (e.g., a NAN device 105 may relay information from an upstream neighbor to a downstream neighbor, or vice versa). For instance, NAN device 105-a may transmit environmental condition information corresponding to its location to NAN device 105-b. NAN device 105-b may transmit its own environmental information to NAN device 105-c, as well as relay the environmental condition information pertaining to NAN device 105-a. Accordingly, NAN device 105-c may relay the environmental condition information received from NAN device 105-b (e.g., NAN device 105-a environmental condition information and NAN device 105-b environmental condition information) to NAN device 105-d, in addition to transmitting environmental information corresponding to the location of NAN device 105-c. In a similar fashion, NAN device 105-d may relay the environmental condition information received from NAN device 105-c, as well as send environmental information corresponding to the location of NAN device 105-d, to NAN device 105-e. Thus, NAN device 105-e may transmit environmental condition information to the route determining device 200 that pertains to NAN device 105-e, NAN device 105-d, NAN device 105-c, NAN device 105-b, and NAN device 105-a, respectively. Although described with reference to environmental condition information, the information relayed from one NAN device 105 to another NAN device 105 may include any kind of information, including location information.

The geographic area 215 may include a number of anomalies such as physical obstructions, high temperatures, or poor air quality, which may inhibit a person 205 or object from navigating or moving through the area. For example, the geographic area 215 may include an anomalous area 220, which may be an area exposed to higher temperatures than the remaining portions of the geographic area 215, perhaps as the result of a fire. Additionally, geographic area 215 may include an obstruction 225, which may prevent the person 205 or device 210 from visually confirming an appropriate route through the geographic area 215 or prevent the person 205 or device 210 from identifying and using the optimal path to traversing the geographic area 215. For example, the obstruction 225 may prevent the person 205 from taking a direct route to a safe location 230 on the other side of the geographic area 215. Thus, the person 205 may have two route options (e.g., route 235-a and route 235-b) for travelling to a safe location 230.

The person 205 may receive route information from the route determining device 200 indicating which route to take (e.g., the route information may be communicated verbally over a wireless communication system or activate a visual indicator in the proximity of the person 205). Additionally or alternatively, the device 210 associated with the person 205 may receive the route information, which may then be visually, audibly, or tactilely conveyed to the person 205. Irrespective of which mobile target (e.g., the person 205 or the device 210) receives the selected route from the route determining device 200, the person 205 may use the route information to direct his or her path (e.g. the person 205 may avoid areas with detected anomalies, such as anomalous area 220). Alternatively, a non-human mobile target, such as an intelligent unmanned vehicle, may receive the selected route from the route determining device 200 and autonomously traverse the geographic area 215 according to the selected route. Although route determining device 200 is shown as a separate entity from the mobile target, in some examples the route determining device 200 may be collocated with or implemented by the mobile target (e.g., the device 210 or another mobile target may also serve as a route determining device 200).

Thus, environmental information conveyed via NAN devices 105 may be used to determine a route. For example, a firefighter may enter an area (e.g., geographic area 215) which may experience drastic environmental changes (e.g., air quality may be reduced by smoke, and temperature may be increased due to fire). The firefighter may roam about the area and intend to use a particular route (e.g., route 235-b) as an exit route. However, changing conditions may render the intended exit route unnavigable. Instead of guessing the intended exit route is safe, the firefighter may use route information from the route determining device 200 to choose a safer route (e.g., route 235-a). In another example, the information from the NAN devices 105 may be used by route determining device 200 to locate a fallen or lost firefighter.

Although the NAN devices 105 are depicted as being distributed by a single person 205, in some instances the NAN devices 105 may be distributed by more than one person 205. In such instances, the distributed NAN devices 105 may be grouped in NAN clusters 115 according to some criteria (e.g., an ID associated with a particular person 205) or may all be part of the same NAN cluster 115. Additionally, a route determining device 200 may be in communication with more than one mobile target (e.g., a team of firefighters). Thus, a route determining device 200 may determine a route for a person 205 based on information corresponding to an area the person 205 has not yet encountered.

In some cases, the route determining device 200 may be located outside of the geographic area 215. The route determining device 200 may act as a control center which monitors a number of routes into, out of, and within geographic area 215, using information from one or more NAN clusters 115. Alternatively, the route determining device 200 may relay (e.g., via wireless communications) information to another device which acts as a control center. The control center may receive information pertaining to the geographic area 215 such as route information, environmental condition data, NAN device 105 information (e.g., locations, operating conditions, etc.), and the like, and use the information to direct the movement of one or more persons 205 (e.g., individual firefighters within a team). For instance, the control center may aggregate and analyze data from multiple sources (e.g., NAN devices 105 or NAN clusters 115) within the geographic area 215 and generate a comprehensive network of routes by which the control center may direct traffic (e.g., persons 205 or vehicles). The control center may maintain and update the network of routes according to information received pertaining to the geographic area 215 (e.g., a route may change course based on environmental factors that render a certain portion of the route impassable).

Regardless of the presence of a control center, a NAN cluster 115-a of NAN devices 105 may monitor the environmental conditions of their respective locations within a geographic area 215 and relay the environmental conditions to a route determining device 200. The route determining device 200 may analyze the environmental condition information and determine a route through the geographic area 215. The route determining device 200 may detect an anomalous area 220 of the geographic area 215 based on the information provided by the NAN devices 105. Thus, the route determining device 200 may determine a route 235-a through the geographic area 215 that avoids the anomalous area 220. The route determining device 200 may communicate the selected route to a mobile target (e.g., a person 205 or a device 210), thereby enabling the mobile target to traverse the geographic area 215 according to the selected route 235-a.

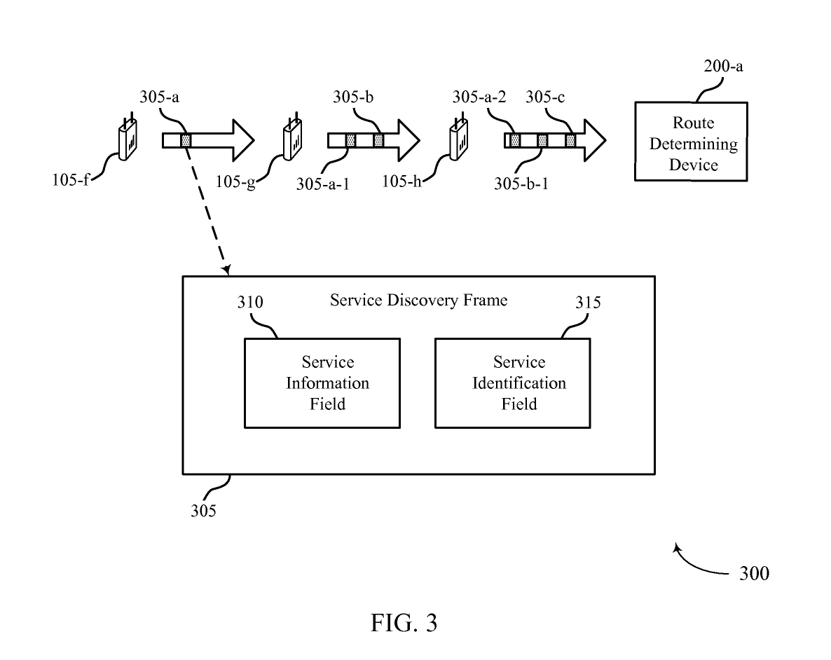

FIG. 3 illustrates an example of a NAN cluster relay 300 for determining a route through a geographic area 215 in accordance with various aspects of the present disclosure. NAN cluster relay 300 may include NAN device 105-f, NAN device 105-g, and NAN device 105-h, which may be examples of a NAN device 105 described above with reference to FIGS. 1 and 2. Each NAN device 105 may communicate with a neighbor NAN device 105 according to the NAN communication scheme generally described above with reference to FIGS. 1 and 2. NAN devices 105 may transmit service discovery frames 305 during discovery windows to advertise services and search for services offered by other NAN devices 105.

A service discovery frame 305 may be formatted to include a service information field 310 and a service identification (ID) field 315. The service information field 310 may be a field of variable size that conveys what type of service is available from one NAN device 105 to another NAN device 105 (e.g., the service information field 310 may contain a hash of the service name). In other words, the information conveyed by the service information field 310 may be accessed by NAN devices 105 to determine what type of service is being offered by another NAN device 105. However, according to aspects of the present disclosure, the service information field may also convey application-specific information (e.g., environmental condition information). The service ID field 315 may be a field of variable size that contains the service specific information. Similar to the service information field 310, the service ID field 315 may also convey application-specific data (e.g., environmental condition information). Service discovery frame 305 may include other fields which may be used to convey information from one NAN device 105 to another.

NAN device 105-f may transmit a first service discovery frame 305-a to NAN device 105-g. The service discovery frame 305-a may convey environmental condition information corresponding to the location of NAN device 105-f, and may be conveyed via a service information field 310, a service ID field 315, or both. NAN device 105-g may transmit a service discovery frame 305-b, which may convey environmental condition information corresponding to the location of NAN device 105-g. NAN device 105-g may also transmit a service discovery frame 305-a-1, which may convey environmental condition information corresponding to the location of NAN device 105-f (i.e., NAN device 105-g may relay information pertaining to NAN device 105-f). Similarly, NAN device 105-h may transmit environmental condition information corresponding to NAN device 105-f and NAN device 105-g via service discovery frame 305-a-2 and service discovery frame 305-b-1, respectively. Additionally, NAN device 105-h may transmit environmental condition information corresponding to its location via service discovery frame 305-c. NAN device 105-h may transmit the service discovery frames 305 to route determining device 200-a, which may be an example of the route determining device 200 described with reference to FIG. 2. Route determining device 200-a may be an anchor master NAN device 105.

Although the service discovery frames 305 of FIG. 3 are shown transmitted according to the physical placement of the NAN devices 105, the ordering of service discovery frames 305 may be based on various criteria. For instance, a NAN device 105 may transmit a service discovery frame with environmental condition information in response to a change in environmental conditions. The change in environmental conditions may trigger a transmission of data if the change satisfies a threshold. In this or other examples, the change in environmental conditions may be experienced by the NAN device 105 transmitting the service discovery frame, or by a different NAN device 105. Service discovery frame 305 may convey only the change in the environmental conditions (e.g., the change in air quality). A transmission of information from a NAN device 105 may be based on additional or alternative factors, such as the expiry of a timer (e.g., the information may be sent periodically) or upon request (e.g., by another NAN device 105 or route determining device 200-a). Route determining device 200-a may transmit the determined route to a mobile target periodically or aperiodically (e.g., when the route changes, or upon request).

The environmental information transmitted between the NAN devices 105 may include data from one or more sensors (e.g., temperature, pressure, accelerometer, humidity, location, etc.), digital media (e.g., pictures, audio, or video), or both. Additionally, the information may be transmitted to a monitoring station, which may be an example of the route determining device 200 described in FIGS. 1-2 or another device altogether. This communication scheme may be employed in emergency situations such as search and rescue missions. For example, global system positioning (GPS) enabled NAN devices 105 may be distributed throughout a search area by volunteers (e.g., in a grid formation). The NAN devices 105 may take snapshots of their respective areas and relay them to a monitoring station. In some examples, the NAN devices 105 may be configured to intelligently parse their respective snapshots, make a determination that a person (e.g., a lost hiker) is in the area, and relay that information to a monitoring station.

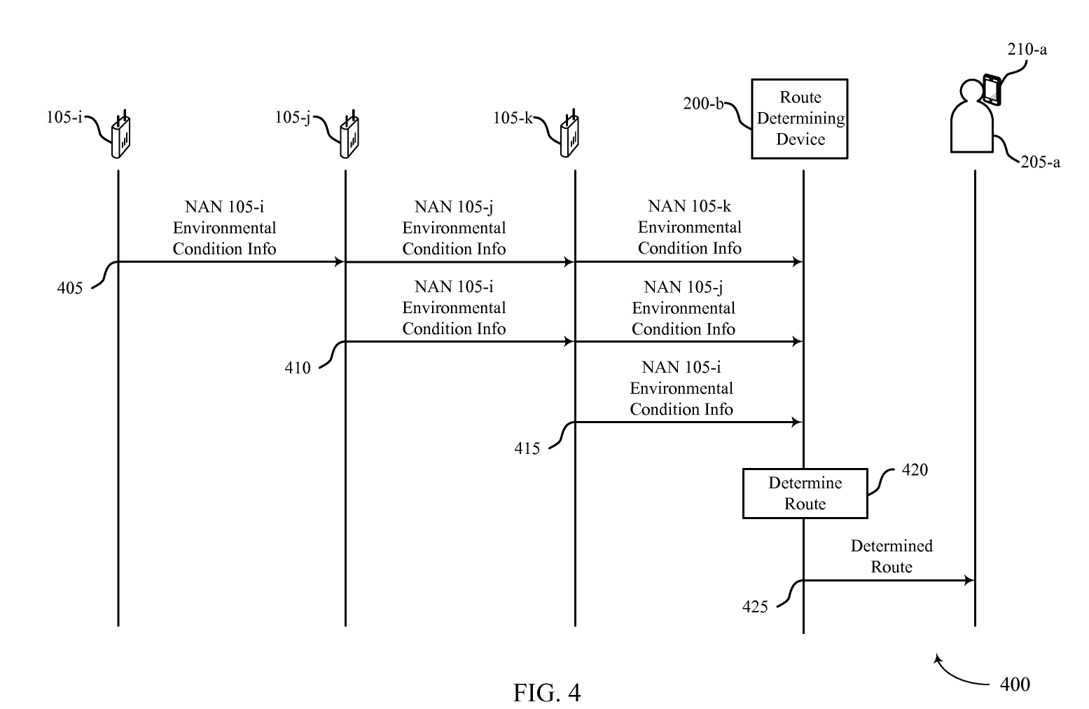

FIG. 4 illustrates an example of a process flow 400 for determining a route through a geographic area 215 in accordance with various aspects of the present disclosure. Process flow 400 may include NAN device 105-i, NAN device 105-j, and NAN device 105-k, which may be examples of a NAN device 105 described with reference to FIGS. 1-3. The NAN devices 105 may communicate environmental condition information via service discovery frames sent during discovery windows, as described with reference to FIGS. 1-3.

At 405, NAN device 105-i may transmit environmental condition information corresponding to its location to 105-j during a discovery window. During the same discovery window, NAN device 105-j may transmit environmental condition information corresponding to its location to NAN device 105-k, and NAN device 105-k may transmit environmental condition information corresponding to its location to route determining device 200-b. Thus, at 405, route determining device 200-b may receive environmental condition information from a set of NAN devices 105 distributed throughout a geographic area. In some examples, the environmental condition information may be conveyed via service discovery frames 305. The service discovery frame 305 may include a service information field 310 configured to convey the environmental condition information. Alternatively or additionally, the service discovery frame 305 may include a service ID field 315 configured to convey the environmental condition information.

Although shown as occurring during the same discovery window, the service discovery frame 305 transmissions may occur during different discovery windows. The environmental condition information may be received at route determining device 200-b periodically. In some examples, receiving the environmental condition information may include receiving a first service discovery frame 305 from a first NAN device 105 (e.g., NAN device 105-k) of a plurality of NAN devices 105. The first service discovery frame may include environmental condition information related to the first NAN device (e.g., NAN device 105-k).

At 410, NAN device 105-j may relay NAN device 105-i environmental condition information to NAN device 105-k. Similarly, NAN device 105-k may relay NAN device 105-j environmental condition information to route determining device 200-b. In other words, route determining device 200-b may receive a second service discovery frame 305 from the first NAN device 105 (e.g., NAN device 105-k) and the second service discovery frame 305 may include additional environmental condition information related to a second NAN device 105 (e.g., NAN device 105-j). The environmental condition information may be received based at least in part on a change in the environmental condition information. In some examples, the environmental condition information may be received if the change in environmental information satisfies a threshold.

At 415, NAN device 105-k may transmit the environmental condition information corresponding to NAN device 105-i to route determining device 200-b. The environmental condition information may include one or more of air quality information, temperature information, visibility information, humidity information, imagery, audio, and video.

At 420, route determining device 200-b may determine a route through a geographic area 215 based on the environmental condition information corresponding to the NAN devices 105. Route determining device 200-b may identify a location associated with a NAN device 105 of the set of the NAN devices 105. In some examples, the route is further based on the location of the NAN device. Route determining device 200-b may detect an anomaly within the physical area based on the environmental condition information. Thus, route determining device 200-a may indicate a path for a mobile target to traverse the geographic area 215. The route may indicate physical areas to avoid within the geographic area 215.

At 425, route determining device 200-b may communicate the determined route to the mobile target (e.g., person 205-a or device 210-a). In other words, the route determining device 200-b may communicate the route to a mobile target associated with the geographic area 215.

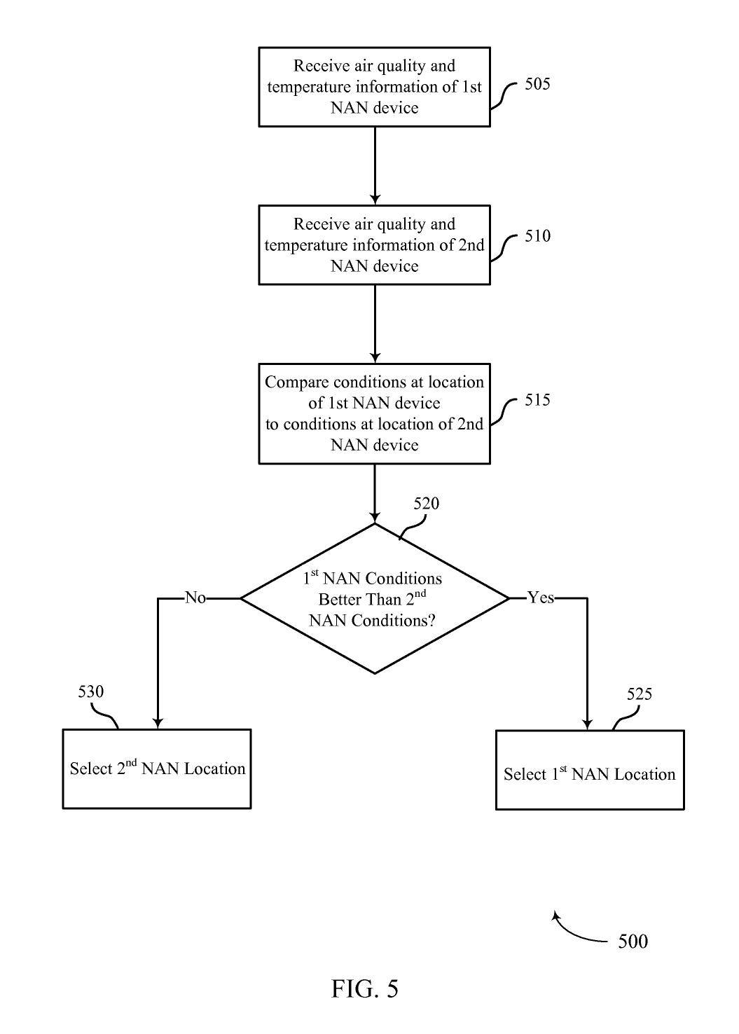

FIG. 5 illustrates an example of a flowchart 500 for determining a route through a geographic area 215 in accordance with various aspects of the present disclosure. In particular, the example of FIG. 5 is given within the context of a firefighting operation in which a firefighter is traveling by foot through a building to extinguish a fire. The operations of flowchart 500 may be implemented by a route determining device 200, as described with reference to FIGS. 2, 3, and 4. According to this illustration, the route determining device 200 may be a portable computer, cellular phone or tablet, or other intelligent device in communication with a NAN cluster 115. The route determining device 200 may be in the possession of the firefighter as the firefighter traverses the building. Alternatively, the route determining device 200 may be located away from the firefighter but may communicate with the firefighter directly (e.g., by controlling audio or visual alerts in the vicinity of the firefighter) or with a device in the possession of the firefighter (e.g., through a Wi-Fi, cellular, or other connection with a phone or tablet carried by the firefighter). The recipient of these communications from the route determining device 200 (e.g., the firefighter or the device in the firefighter's possession) may also be referred to as a mobile target.

While navigating the building, the firefighter may distribute NAN devices 105 at various points within the building. The firefighter may distribute the NAN devices 105 manually or rely on an automated distribution device, or a combination of the two. The firefighter may distribute the NAN devices at his or her discretion, or according to a prompt (e.g., a sensor associated with the RSSI of the nearest NAN device 105 may alert the firefighter when a NAN device 105 should be distributed). The automated distribution device may deploy the NAN devices 105 based on one or more criteria which may include the RSSI of the nearest master NAN device 105, a timer, a change in conditions, or an external prompt (e.g., from the route determining device 200). Upon deployment, the NAN devices 105 may monitor the conditions of their respective surroundings (e.g., air quality, temperature, humidity, etc.) and report the information to the route determining device 200 (e.g., through a relay using service discovery frames 305). The reported information may include information unrelated to the environmental conditions of the area, such as the location of the NAN devices 105, or the time elapsed since the NAN devices 105 were deployed. Alternatively, the route determining device 200 may ascertain the locations of the NAN devices 105 through some other means (e.g., via collocated GPS devices).

At block 505, the route determining device 200 may receive air quality and temperature information corresponding to a first NAN device 105. The first NAN device 105 may be located at a point in the building where the firefighter or collocated distribution device deployed the first NAN device 105. The environmental condition information may include raw air quality and temperature measurements at the location of the first NAN device 105, or may instead include information pertaining to a change in the air quality or temperature. The information may be received based on a periodic reporting schedule or in response to a request from the route determining device 200. In one example, the reception may be triggered by a change in the air quality or temperature information at the location of the first NAN device 105.

At block 510, route determining device 200 may receive air quality and temperature information corresponding to a second NAN device 105, which may have been deployed by the firefighter at a different location than the first NAN device 105. The first NAN device 105 and the second NAN device 105 may be part of a NAN cluster 115 distributed throughout the building. Furthermore, the first NAN device 105 and the second NAN device 105 may represent two options for a route to safety for the firefighter (e.g. they may be located at a first stairwell and a second stairwell).

At block 515, the route determining device 200 may compare the information (e.g., the air quality and temperature data) of the first NAN device 105 to the information (e.g., the air quality and temperature data) of the second NAN device 105. At decision block 520, the route determining device 200 may decide which environmental conditions are more appropriate for the firefighter between the two NAN devices 105, based on the comparison. If the conditions measured at the location of the first NAN device 105 are more appropriate for the firefighter than the conditions measured at the location of the second NAN device 105 (e.g., if the air quality is higher or the temperature is lower at the location of the first NAN device 105 than at the location of the second NAN device 105), at block 525 the route determining device 200 may select the location of the first NAN device 105 (e.g., the first stairwell) for the route. If the environmental conditions for the second NAN device 105 are better than the conditions for the first NAN device 105, at block 530 the route determining device 200 may select the location of the second NAN device 105 (e.g., the second stairwell) for the route.

Upon selection of the most appropriate route for the firefighter, the route determining device 200 may communicate the information to the firefighter. The information may be conveyed via a wireless communication system, either to a mobile device carried by the firefighter, which the firefighter may reference, or to the firefighter directly, via audio or visual stimulation. In one example, the firefighter may possess a handheld device which displays the locations of the NAN devices 105 relative to the firefighter. The information conveyed by route determining device 200 may alter the appearance of the NAN devices 105 whose locations are compromised due to hazardous environmental conditions. Thus, the firefighter may reference the mapping of the NAN devices 105 and choose to avoid areas with low quality conditions. In an alternative, the information may be communicated indirectly, via an intermediary (e.g., via the firefighter's captain, a proxy device, or a control center). Irrespective of how the information is conveyed to the firefighter, the firefighter may use the information to choose a route to safety which avoids hazardous conditions.

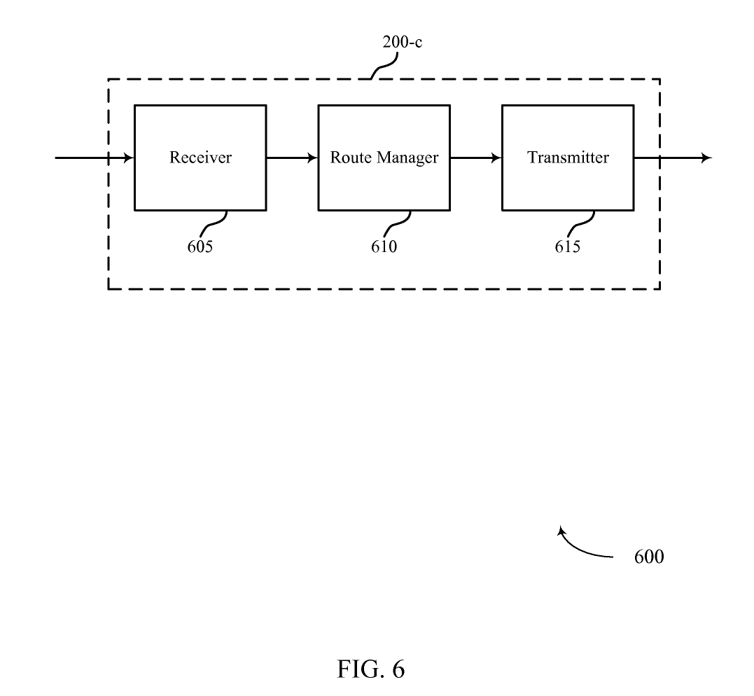

FIG. 6 shows a block diagram 600 of a route determining device 200-c in accordance with various aspects of the present disclosure. Route determining device 200-c may be an example of aspects of a route determining device 200 described with reference to FIGS. 2-5. Route determining device 200-c may include a receiver 605, a route manager 610, or a transmitter 615. Route determining device 200-c may also include a processor. Each of these components may be in communication with each other.

The components of route determining device 200-c may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 605 may receive information corresponding to individual NAN devices 105 within a NAN cluster 115 (e.g., environmental condition information or location information). The received information may be passed on to the route manager 610, and to other components of route determining device 200-c.

The route manager 610 may receive environmental condition information from a plurality of NAN devices distributed throughout a geographic area 215 and determine a route through the geographic area 215. In some cases, the route may be based at least in part on the environmental condition information. The environmental condition information may be passed to the route manager 610 from receiver 605. The route manager 610 may be configured such that the environmental condition information may be received periodically or aperiodically, as described above with reference to FIGS. 2-6.

The transmitter 615 may transmit signals received from other components of route determining device 200-c (e.g., the transmitter 615 may communicate the route determined by route manager 610 to a mobile target associated with the geographic area 215). In some embodiments, the transmitter 615 may be collocated with the receiver 605 in a transceiver. The transmitter 615 may include a single antenna, or it may include a plurality of antennas.

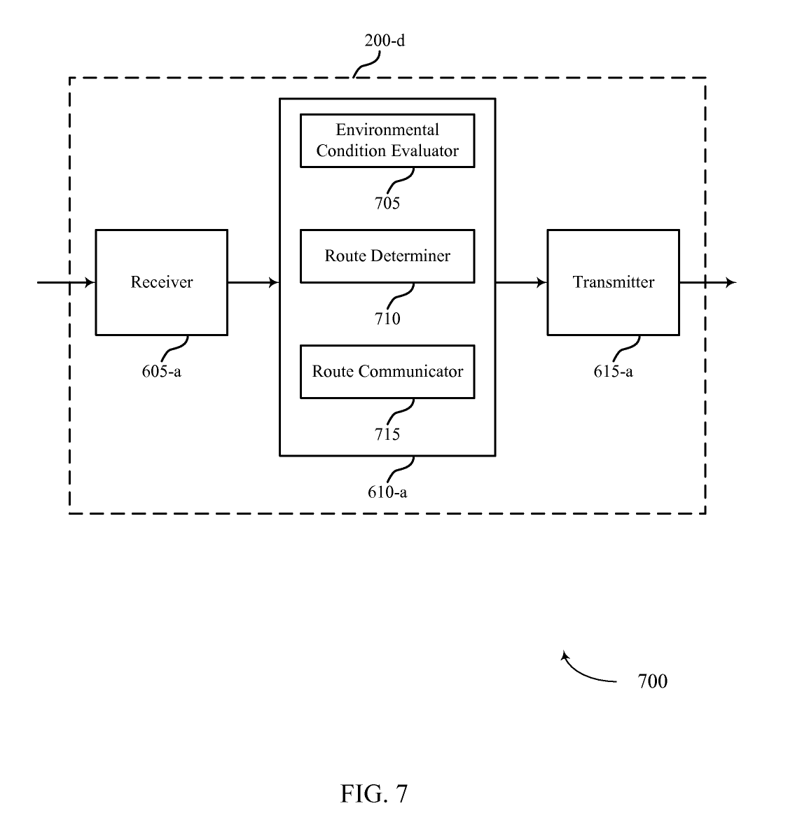

FIG. 7 shows a block diagram 700 of a route determining device 200-d in accordance with various aspects of the present disclosure. Route determining device 200-d may be an example of a route determining device 200 described with reference to FIGS. 2-6. Route determining device 200-d may include a receiver 605-a, a route manager 610-a, or a transmitter 615-a, which may be aspects of receiver a 605, route manager 610, and transmitter 615, respectively, as described with reference to FIG. 6. Route determining device 200-d may also include a processor. Each of these components may be in communication with each other. The route manager 610-a may also include an environmental condition evaluator 705, a route determiner 710, and a route communicator 715.

The components of route determining device 200-d may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 605-a may receive information from NAN devices 105 which may be passed on to route manager 610-a, and to other components of route determining device 200-d. The route manager 610-a may perform the operations described above with reference to FIG. 6. The transmitter 615-a may transmit signals received from other components of route determining device 200-d.

The environmental condition evaluator 705 may receive environmental condition information from a plurality of NAN devices 105 distributed throughout a geographic area 215 as described above with reference to FIGS. 2-6. The environmental condition evaluator 705 may evaluate the environmental data and communicate with the route determiner 710. In some cases, the evaluation may include comparing environmental data for different NAN devices 105. In some example, the evaluation may include determining if a threshold has been satisfied.

The route determiner 710 may determine a route through a geographic area 215, the route based at least in part on the environmental condition information as described above with reference to FIGS. 2-6. Additionally or alternatively, the route may be based on information from environmental condition evaluator 705. In some examples, the route indicates a path for the mobile target to traverse the geographic area 215, the route indicating physical areas to avoid within the geographic area 215.

The route communicator 715 may generate a message to the mobile target indicating the route determined through the geographic area 215 as described above with reference to FIGS. 2-6. In some cases, the transmitter 615-a may transmit the generated message to the mobile target wirelessly. Alternatively, the route communicator 715 may directly control a display, audio device, or other wired device to communicate the signal to the mobile target. The route may be communicated to the mobile target periodically or aperiodically.

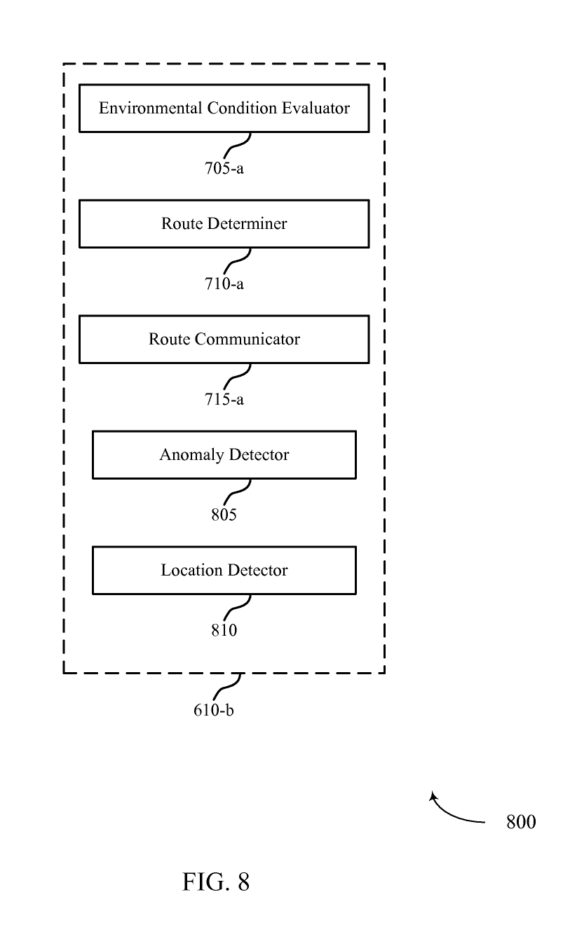

FIG. 8 shows a block diagram 800 of a route manager 610-b in accordance with various aspects of the present disclosure. The route manager 610-b may be an example of aspects of a route manager 610 described with reference to FIGS. 6-7. The route manager 610-b may include an environmental condition evaluator 705-a, a route determiner 710-a, and a route communicator 715-a. Each of these components may perform the functions described above with reference to FIG. 7. The route manager 610-b may also include an anomaly detector 805 and a location detector 810.

The components of the route manager 610-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The environmental condition evaluator 705-a may receive and evaluate environmental condition information from the NAN devices 105. The evaluation may be based in part on dynamic or predetermined criteria or thresholds. The environmental condition evaluator 705-a may be in communication with the route determiner 710-a, which may use the environmental condition information to determine a route. In some cases, the route determiner 710-a may base the route at least in part on information passed to the route determiner 710-a from environmental condition evaluator 705-a. The route communicator 715-a may generate a message indicating the determined route, or route information, for the transmitter 615 to transmit to the mobile target.

The anomaly detector 805 may detect an anomaly within the physical area based on the environmental condition information as described above with reference to FIGS. 2-6. The anomaly may be based on a change in environmental conditions. In some cases, the anomaly may be based on a difference between environmental conditions for one or more NAN devices 105.

The location detector 810 may identify a location associated with a NAN device 105 of the plurality of a NAN devices 105 as described above with reference to FIGS. 2-6. The location detector may identify a NAN device 105 location based on information transmitted from a NAN device 105, or based on some other data (e.g., information from a GPS). In some examples, the route determined by route manager 610 may be based on the location of the NAN device 105.

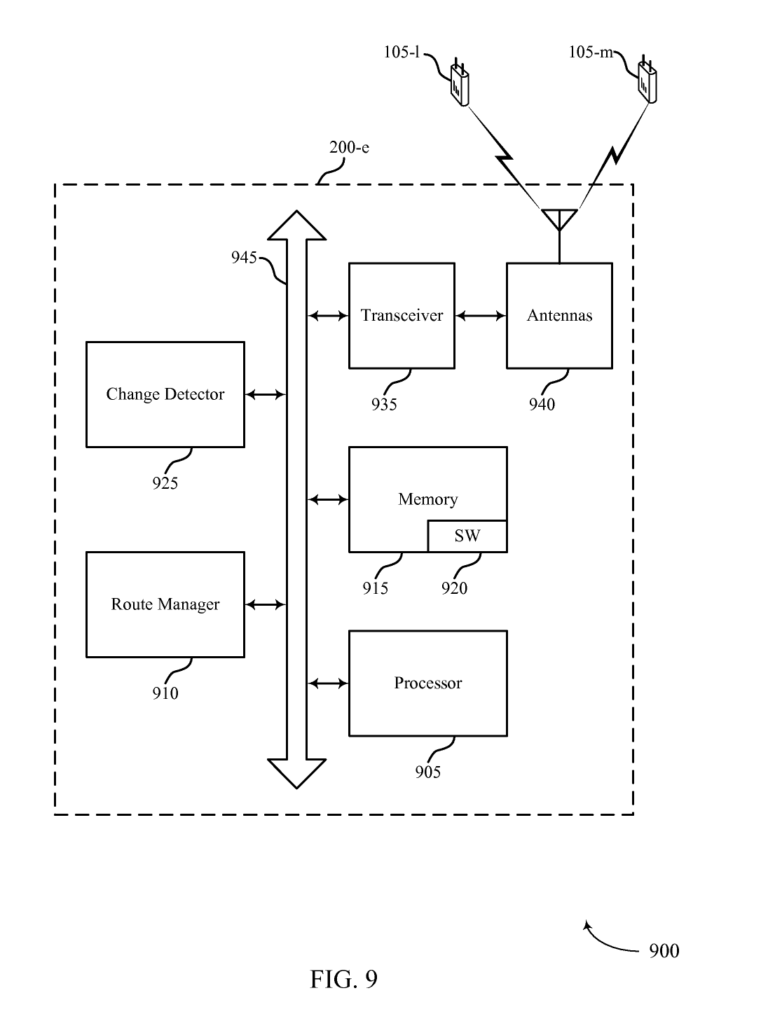

FIG. 9 illustrates a block diagram of a system 900 including a route determining device 200 in accordance with various aspects of the present disclosure. System 900 may include route determining device 200-e, which may be an example of a route determining device 200 described above with reference to FIGS. 2-8. Route determining device 200-e may include a route manager 910, which may be an example of a route manager 610 described with reference to FIGS. 6-8. Route determining device 200-e may also include a change detector 925. Route determining device 200-e may include components for bi-directional voice and data communications including components for transmitting communications and components for receiving communications. For example, route determining device 200-e may communicate bi-directionally with NAN device 105-l or NAN device 105-m.

The change detector 925 may be configured such that the environmental condition information may be received based at least in part on a change in the environmental condition information as described above with reference to FIGS. 2-6. The change detector 925 may be configured such that the determined route may be communicated to the mobile target based at least in part on a change in the environmental condition information as described above with reference to FIGS. 2-6. The environmental condition information may be received if the change in environmental information satisfies a threshold. The route may be communicated to the mobile target if the change in environmental information satisfies a threshold.

Route determining device 200-e may also include a processor 905, and memory 915 (including software (SW) 920), a transceiver 935, and one or more antenna(s) 940, each of which may communicate, directly or indirectly, with one another (e.g., via buses 945). The transceiver 935 may communicate bi-directionally, via the antenna(s) 940 or wired or wireless links, with one or more networks, as described above. For example, the transceiver 935 may communicate bi-directionally with a NAN device 105 or another route determining device 200. The transceiver 935 may include a modem to modulate the packets and provide the modulated packets to the antenna(s) 940 for transmission, and to demodulate packets received from the antenna(s) 940. While route determining device 200-e may include a single antenna 940, route determining device 200-e may also have multiple antennas 940 capable of concurrently transmitting or receiving multiple wireless transmissions.

The memory 915 may include random access memory (RAM) and read only memory (ROM). The memory 915 may store computer-readable, computer-executable software/firmware code 920 including instructions that, when executed, cause the processor 905 to perform various functions described herein (e.g., determine a route through a geographic area 215 based on environment conditional information, etc.). Alternatively, the software/firmware code 920 may not be directly executable by the processor 905 but cause a computer (e.g., when compiled and executed) to perform functions described herein. The processor 905 may include an intelligent hardware device (e.g., a central processing unit (CPU), a microcontroller, an ASIC, etc.).

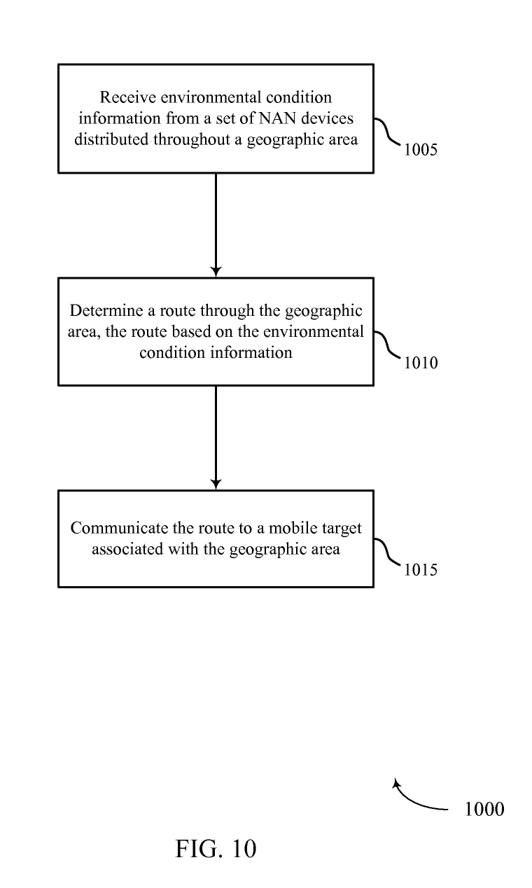

FIG. 10 shows a flowchart illustrating a method 1000 for determining a route through a geographic area 215 in accordance with various aspects of the present disclosure. The operations of method 1000 may be implemented by a route determining device 200 or its components as described with reference to FIGS. 2-9. For example, the operations of method 1000 may be performed by the route manager 610 as described with reference to FIGS. 6-9. In some examples, a route determining device 200 may execute a set of codes to control the functional elements of the route determining device 200 to perform the functions described below. Additionally or alternatively, the route determining device 200 may perform aspects the functions described below using special-purpose hardware.

At block 1005, the route determining device 200 may receive environmental condition information from a plurality of NAN devices 105 distributed throughout a geographic area 215 as described above with reference to FIGS. 1-6. In certain examples, the operations of block 1005 may be performed by the environmental condition evaluator 705 as described above with reference to FIG. 7.

At block 1010, the route determining device 200 may determine a route through a geographic area 215. The route may be based at least in part on the environmental condition information, as described above with reference to FIGS. 2-6. In certain examples, the operations of block 1010 may be performed by the route determiner 710 as described above with reference to FIG. 7.

At block 1015, the route determining device 200 may communicate the route to a mobile target associated with the geographic area 215, as described above with reference to FIGS. 2-6. In certain examples, the operations of block 1015 may be performed by the route communicator 715 as described above with reference to FIG. 7.

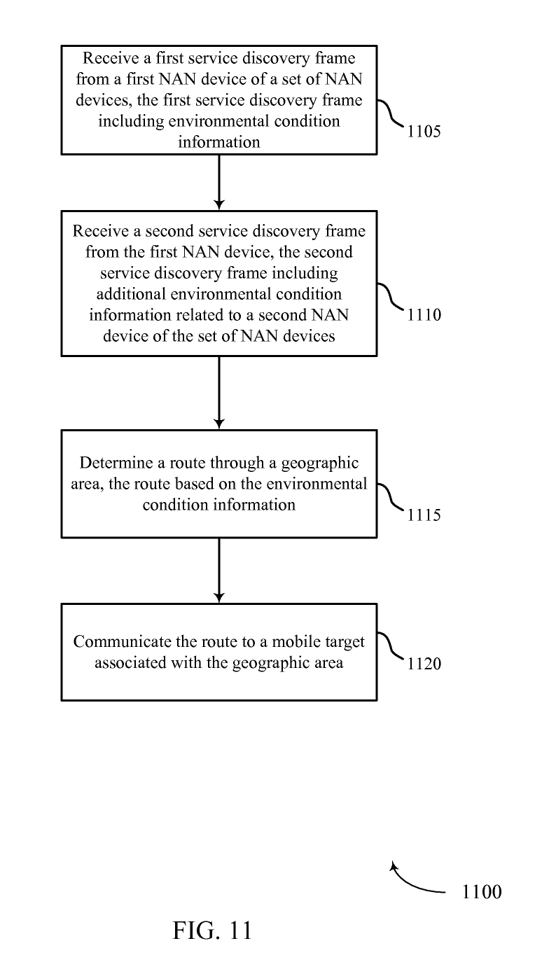

FIG. 11 shows a flowchart illustrating a method 1100 for determining a route through a geographic area 215 in accordance with various aspects of the present disclosure. The operations of method 1100 may be implemented by a route determining device 200 or its components as described with reference to FIGS. 1-10. For example, the operations of method 1100 may be performed by the route manager 610 as described with reference to FIGS. 6-10. In some examples, a route determining device 200 may execute a set of codes to control the functional elements of the route determining device 200 to perform the functions described below. Additionally or alternatively, the route determining device 200 may perform aspects the functions described below using special-purpose hardware. The method 1100 may also incorporate aspects of method 1000 of FIG. 10.

At block 1105, the route determining device 200 may receive a first service discovery frame from a first NAN device 105 of a set of NAN devices 105. The first service discovery frame 305 may include environmental condition information. In some instances, the environmental condition information may be related to the first NAN device 105. In certain examples, the operations of block 1105 may be performed by the environmental condition evaluator 705 as described above with reference to FIG. 7.

At block 1110, the route determining device 200 may receive a second service discovery frame 305 from the first NAN device 105. The second service discovery frame 305 may comprise additional environmental condition information related to a second NAN device 105 of the plurality of NAN devices 105 as described above with reference to FIGS. 2-6. In certain examples, the operations of block 1110 may be performed by the environmental condition evaluator 705 as described above with reference to FIG. 7.

At block 1115, the route determining device 200 may determine a route through a geographic area 215, the route based at least in part on the environmental condition information and as described above with reference to FIGS. 2-6. In certain examples, the operations of block 1115 may be performed by the route determiner 710 as described above with reference to FIG. 7.

At block 1120, the route determining device 200 may communicate the route to a mobile target associated with the geographic area 215 as described above with reference to FIGS. 2-6. In certain examples, the operations of block 1120 may be performed by the route communicator 715 as described above with reference to FIG. 7.

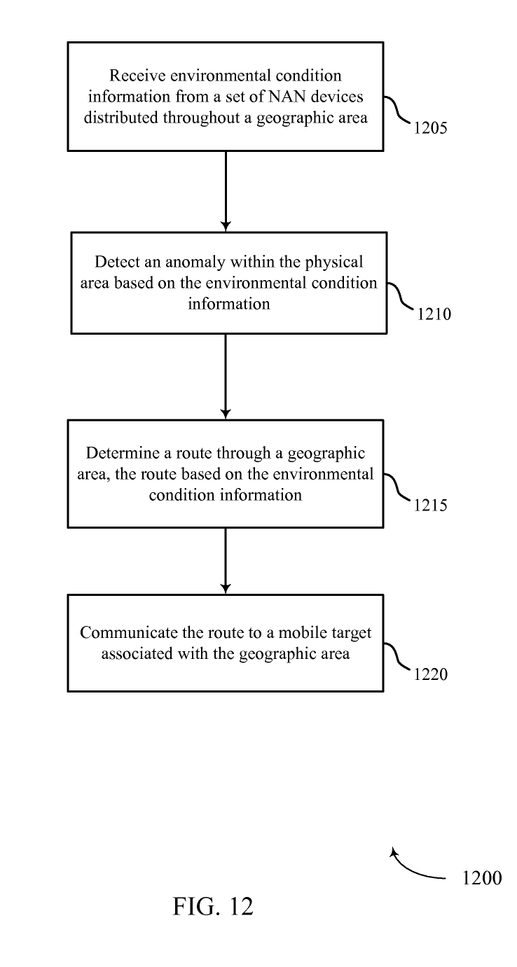

FIG. 12 shows a flowchart illustrating a method 1200 for determining a route through a geographic area 215 in accordance with various aspects of the present disclosure. The operations of method 1200 may be implemented by a route determining device 200 or its components as described with reference to FIGS. 1-9. For example, the operations of method 1200 may be performed by the route manager 610 as described with reference to FIGS. 6-9. In some examples, a route determining device 200 may execute a set of codes to control the functional elements of the route determining device 200 to perform the functions described below. Additionally or alternatively, the route determining device 200 may perform aspects the functions described below using special-purpose hardware. The method 1200 may also incorporate aspects of methods 1000 and 1100 of FIGS. 10 and 11.

At block 1205, the route determining device 200 may receive environmental condition information from a plurality of NAN devices 105 distributed throughout a geographic area 215 as described above with reference to FIGS. 2-6. In certain examples, the operations of block 1205 may be performed by the environmental condition evaluator 705 as described above with reference to FIG. 7.

At block 1210, the route determining device 200 may detect an anomaly within the geographic area 215 based on the environmental condition information as described above with reference to FIGS. 2-6. In certain examples, the operations of block 1210 may be performed by the anomaly detector 805 as described above with reference to FIG. 8.

At block 1215, the route determining device 200 may determine a route through a geographic area 215, the route based at least in part on the environmental condition information and as described above with reference to FIGS. 2-6. In some cases, the route indicates a path for the mobile target to traverse the geographic area 215. In this or other examples, the route indicates physical areas to avoid within the geographic area 215. In certain examples, the operations of block 1215 may be performed by the route determiner 710 as described above with reference to FIG. 7.

At block 1220, the route determining device 200 may communicate the route to a mobile target associated with the geographic area 215 as described above with reference to FIGS. 2-6. In certain examples, the operations of block 1220 may be performed by the route communicator 715 as described above with reference to FIG. 7.

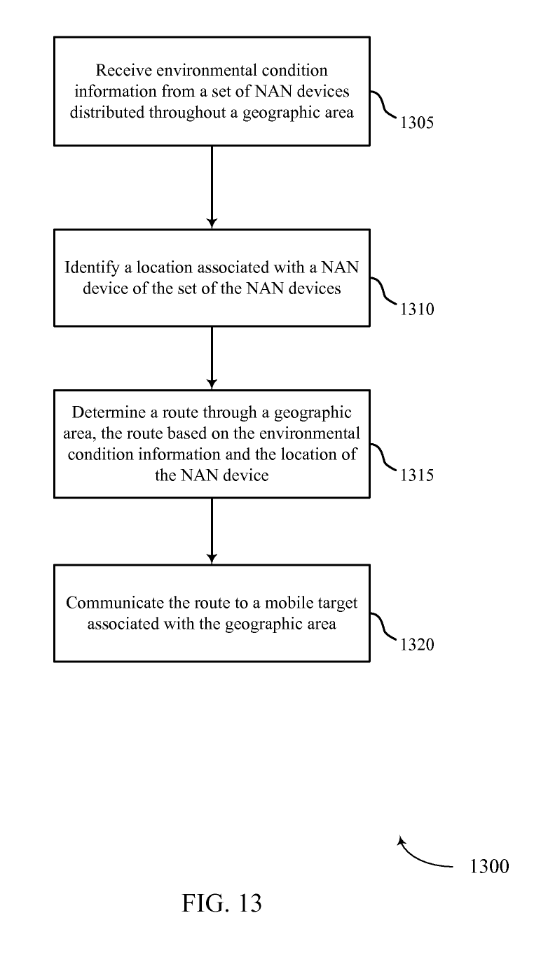

FIG. 13 shows a flowchart illustrating a method 1300 for determining a route through a geographic area in accordance with various aspects of the present disclosure. The operations of method 1300 may be implemented by a route determining device 200 or its components as described with reference to FIGS. 1-9. For example, the operations of method 1300 may be performed by the route manager 610 as described with reference to FIGS. 6-9. In some examples, a route determining device 200 may execute a set of codes to control the functional elements of the route determining device 200 to perform the functions described below. Additionally or alternatively, the route determining device 200 may perform aspects the functions described below using special-purpose hardware. The method 1300 may also incorporate aspects of methods 1000, 1100, and 1200 of FIGS. 10-12.

At block 1305, the route determining device 200 may receive environmental condition information from a plurality of NAN devices 105 distributed throughout a geographic area 215 as described above with reference to FIGS. 2-6. In certain examples, the operations of block 1305 may be performed by the environmental condition evaluator 705 as described above with reference to FIG. 7.

At block 1310, the route determining device 200 may identify a location associated with a NAN device 105 of the plurality of the NAN devices 105 as described above with reference to FIGS. 2-6. In certain examples, the operations of block 1310 may be performed by the location detector 810 as described above with reference to FIG. 8.

At block 1315, the route determining device 200 may determine a route through a geographic area 215, the route based at least in part on the environmental condition information and as described above with reference to FIGS. 2-6. In some examples, the route is further based on the location of the NAN device 105. In certain examples, the operations of block 1315 may be performed by the route determiner 710 as described above with reference to FIG. 7.

At block 1320, the route determining device 200 may communicate the route to a mobile target associated with the geographic area 215 as described above with reference to FIGS. 2-6. In certain examples, the operations of block 1320 may be performed by the route communicator 715 as described above with reference to FIG. 7.

Thus, methods 1000, 1100, 1200, and 1300 may provide for determining a route through a geographic area. It should be noted that methods 1000, 1100, 1200, and 1300 describe possible implementation, and that the operations and the steps may be rearranged or otherwise modified such that other implementations are possible. In some examples, aspects from two or more of the methods 1000, 1100, 1200, and 1300 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein (i.e., the receiver 605, route manager 610, and transmitter 615 of FIGS. 6-9; and the processor 905, memory 915, change detector 925, and transceiver 935 of FIG. 9) may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “ or ” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
receiving environmental condition information from a plurality of neighbor awareness network (NAN) devices distributed throughout a geographic area;
determining a route through the geographic area, the route based at least in part on the environmental condition information; and
communicating the route to a mobile target associated with the geographic area.

2. The method of claim 1, wherein receiving the environmental condition information comprises:
receiving a first service discovery frame from a first NAN device of the plurality of NAN devices, the first service discovery frame comprising the environmental condition information.

3. The method of claim 2, wherein the environmental condition information is related to the first NAN device; and
the method further comprising receiving a second service discovery frame from the first NAN device, the second service discovery frame comprising additional environmental condition information related to a second NAN device of the plurality of NAN devices.

4. The method of claim 2, wherein the first service discovery frame comprises a service information field to convey the environmental condition information.

5. The method of claim 2, wherein the first service discovery frame comprises a service identification field to convey the environmental condition information.

6. The method of claim 1, further comprising:
detecting an anomaly within the geographic area based on the environmental condition information; and
wherein the route indicates a path for the mobile target to traverse the geographic area, the route indicating physical areas to avoid within the geographic area.

7. The method of claim 1, further comprising:
identifying a location associated with a NAN device of the plurality of the NAN devices; and
wherein the route is further based on the location of the NAN device.

8. The method of claim 1, wherein the environmental condition information is received periodically.

9. The method of claim 1, wherein the environmental condition information is received based at least in part on a change in the environmental condition information.

10. The method of claim 9, wherein the environmental condition information is received if the change in environmental information satisfies a threshold.

11. The method of claim 1, wherein the environmental condition information comprises one of the group consisting of:
air quality information, temperature information, visibility information, imagery, audio, and video.

12. An apparatus for wireless communication, comprising:
means for receiving environmental condition information from a plurality of neighbor awareness network (NAN) devices distributed throughout a geographic area;
means for determining a route through the geographic area, the route based at least in part on the environmental condition information; and
means for communicating the route to a mobile target associated with the geographic area.

13. The apparatus of claim 12, wherein the means for receiving the environmental condition information comprises:
means for receiving a first service discovery frame from a first NAN device of the plurality of NAN devices, the first service discovery frame comprising the environmental condition information.

14. The apparatus of claim 13, wherein the environmental condition information is related to the first NAN device; and
the apparatus further comprises means for receiving a second service discovery frame from the first NAN device, the second service discovery frame comprising additional environmental condition information related to a second NAN device of the plurality of NAN devices.

15. The apparatus of claim 13, wherein the first service discovery frame comprises a service information field to convey the environmental condition information.

16. The apparatus of claim 13, wherein the first service discovery frame comprises a service identification field to convey the environmental condition information.

17. The apparatus of claim 12, further comprising:
means for detecting an anomaly within the geographic area based on the environmental condition information; and
wherein the route indicates a path for the mobile target to traverse the geographic area, the route indicating physical areas to avoid within the geographic area.

18. The apparatus of claim 12, further comprising:
means for identifying a location associated with a NAN device of the plurality of the NAN devices;
wherein the route is further based on the location of the NAN device.

19. An apparatus for wireless communication comprising:
a processor;
memory in electronic communication with the processor; and
instructions stored in the memory; wherein the instructions are executable by the processor to:
receive environmental condition information from a plurality of neighbor awareness network (NAN) devices distributed throughout a geographic area;
determine a route through the geographic area, the route based at least in part on the environmental condition information; and
communicate the route to a mobile target associated with the geographic area.

20. The apparatus of claim 19, wherein receiving the environmental condition information comprises:
receiving a first service discovery frame from a first NAN device of the plurality of NAN devices, the first service discovery frame comprising the environmental condition information.

21. The apparatus of claim 20, wherein the environmental condition information is related to the first NAN device; and
wherein the instructions are executable by the processor to receive a second service discovery frame from the first NAN device, the second service discovery frame comprising additional environmental condition information related to a second NAN device of the plurality of NAN devices.

22. The apparatus of claim 20, wherein the first service discovery frame comprises a service information field to convey the environmental condition information.

23. The apparatus of claim 20, wherein the first service discovery frame comprises a service identification field to convey the environmental condition information.

24. The apparatus of claim 19, wherein the instructions are executable by the processor to:
detect an anomaly within the geographic area based on the environmental condition information; and
wherein the route indicates a path for the mobile target to traverse the geographic area, the route indicating physical areas to avoid within the geographic area.

25. The apparatus of claim 19, wherein the instructions are executable by the processor to:
identify a location associated with a NAN device of the plurality of the NAN devices; and
wherein the route is further based on the location of the NAN device.

26. The apparatus of claim 19, wherein the environmental condition information is received periodically.

27. The apparatus of claim 19, wherein the environmental condition information is received based at least in part on a change in the environmental condition information.

28. The apparatus of claim 27, wherein the environmental condition information is received if the change in environmental information satisfies a threshold.

29. The apparatus of claim 19, wherein the environmental condition information comprises one of the group consisting of:
air quality information, temperature information, visibility information, imagery, audio, and video.

30. A non-transitory computer-readable medium storing code for wireless communication at a route determining device, the code comprising instructions executable to:
receive environmental condition information from a plurality of neighbor awareness network (NAN) devices distributed throughout a geographic area;
determine a route through the geographic area, the route based at least in part on the environmental condition information; and
communicate the route to a mobile target associated with the geographic area.
